(19) United States
(12) Patent Application Publication
(10) Pub. No.: US 2026/0275783 A1
(43) Pub. Date: Sep. 17, 2026

(54) WATERPROOFING GASKET FOR SHOWER CLAMPS OF FRAMELESS SHOWER ASSEMBLIES

(71) Applicant: Steven Schwartz, Sarasota, FL (US)

(72) Inventor: Steven Schwartz, Sarasota, FL (US)

(21) Appl. No.: 19/370,857

(22) Filed: Oct. 28, 2025

Related U.S. Application Data
(60) Provisional application No. 63/712,548, filed on Oct. 28, 2024.

(51) Int. Cl. E05D 5/02; E05D 5/06

(52) U.S. Cl. CPC E05D 5/0246; E05D 5/06; E05Y 2800/12

(57) ABSTRACT

A frameless shower can be installed by placing a gasket that forms a watertight seal between a shower clamp and a wall surface and securing the shower clamp to the wall surface via screws passing through the shower clamp and the wall surface. The gasket can be a waffle gasket, where the tightening of the screw enhances the strength of the seal. The shower clamp can be a pivot hinge for a door of a frameless shower. In embodiments, the shower clamp can secure a pane of glass, which does not pivot to a wall. In embodiment, the gasket can be sold as part of a kit, which includes screws and anchors. The kit may also include shower clamps. Further, the kit can be part of a full shower installation kit that includes doors, panels, clamps, gaskets, doors, screws, and anchors.

### CROSS-REFERENCE TO RELATED APPLICATIONS

This application claims priority under 35 USC 119(e) to US Provisional Application No. 63/712,546 filed Oct. 28, 2024, the entire contents of which are incorporated by reference in its entirety.

### FIELD OF THE EMBODIMENTS

The field of the invention and its embodiments relates to waterproofing, bathroom structures, and gaskets, and more specifically to an improved waterproofing gasket for shower clamps of frameless shower assemblies.

### Background of the Embodiments

Traditional shower doors, which often slide, use frames and sealants (e.g., silicone-based caulk) to keep water inside the shower. Any homeowner whose old-style shower door has suffered breakage in the caulking or the metal frame knows that leaks will immediately start causing trouble outside the shower.

Frameless showers (see FIG. 1C—PRIOR ART), often have shower dividers, which are planes of glass suspended in the air, which results in a clean, modern aesthetic. Frameless glass doors are often affixed to a wall by a pivot hinge (See FIG. 1A—PRIOR ART). Shower dividers, which are often glass walls, are often present, which are connected to a wall via a shower clamp (see FIG. 3A), and two each other via a fricative, slotted coupler. The present disclosure is directed towards the wall connectors, which support frameless shower doors and panels/dividers. In general, frameless shower arrangements often integrate a variety of tricks to prevent water from leaking out through hinges and openings.

Installation often places a showerhead in ways that direct water away from the door itself. Slight angles can be created in the floor and walls designed to direct water towards the drain instead of allowing it to seep outwards.

Nonetheless, water intrusion remains a significant concern and problem for frameless shower doors and/or modern shower glass walls/dividers. These problems are especially prevalent in installations requiring drilling holes into wall surfaces, bases, or sills for “pivot” hinges (see FIG. 1A—PRIOR ART). Water intrusion concerns are especially acute in multi-family, high-rise buildings, or houses with multiple stories, where the integrity of each unit's waterproofing is crucial.

Installing pivot hinges (FIG. 1A and FIG. 1B—both PRIOR ART) requires drilling into the shower wall/base for installation. This process inherently risks water intrusion, which can lead to damage over time, especially in structures like high-rises or multi-story homes.

With reference to FIG. 1A (PRIOR ART), a wall-mounted, pivot shower hinge, also called a pivot hinge, which is a type of shower clamp as used herein, has a vise or clamshell set of plates within which a glass door/wall is secured. Generally, the shower clamp/pivot hinge can have a T-shape, although embodiments exist where this angle can be adjusted (to adjust a shape/angle of a shower door/panel relative to a wall if not placed perpendicular to the wall). Often two or three parallel shower clamps (see FIG. 1C PRIOR ART, which uses two) secure a pivoting door to a shower wall surface. Each shower clamp is secured to the glass door/panel through a clamping action that squeezes the glass door between two opposing plates positioned parallel to and outside a surface of the glass.

In embodiments, substantially rectangular indentations (e.g., concavities specifically shaped for a shower clamp) exist in the door/panel itself, as shown by FIG. 1B (PRIOR ART). Once installed, the concavity is hidden by the outer surface of the shower clamp (See FIG. 1C). During installation, the clamping plates are separated into parts, where one part is shown in FIG. 1B (PRIOR ART). Often a shower clamp will have internal waterproofing/vibration dampening elements in their interior, as shown by FIG. 1B (PRIOR ART). After being placed in the door, a detached plate is re-attached and tightened, resulting in a fricative fit, which includes the slotted fit shown in FIG. 1B (PRIOR ART) for purposes herein.

Upon installation and when an attached shower door is closed, a wall-attaching plane of the shower clamp is substantially perpendicular to a plane of the glass securing clamp (See FIG. 1A—PRIOR ART). The shower clamp is secured to the wall by first drilling holes, inserting screw anchors into these holes, positioning the wall-attaching plane (or plate) of the shower clamp so holes are aligned, then securing via screws, typically four as shown.

Breaches in the wall surface within which the screw anchors are sunk are often slightly covered using a small amount of silicon caulk or other fluid sealant. Once installed, the door typically swings up to ninety degrees outwardly. It is important to note, the entire weight of a glass door is placed on the shower clamp/pivot hinges. Misalignment of these hinges results in the door opening/closing poorly. Misalignment of the door relative to planes of shower glass (if any) results in water seepages, aesthetic concerns, and improper opening/closure actions of the hinged shower door. Any deviations of a position of the shower clamp relative to either the surface of the wall or to the surface of the glass plane become problematic. Inherently, using a planar surface of a wall (often drywall covered by a tile) to secure a substantially parallel surface (wall-attachment plane of pivot hinge) via screws can be problematic over time, when the screws/wall are constantly subject to moisture, direct water from being part of a shower. This problem is exasperated when tiles (cover the wall) are even slightly misaligned from each other, as limited “shim” abilities exist for the pivot hinge. It is noteworthy that in construction, wall surfaces that have irregularities from a designed vertical are more a norm than an exception.

What is needed, and is not evident in the art, is a better means for securing shower pivot hinges (see FIG. 1A—PRIOR ART) and other shower clamps to a shower wall surface.

### REFERENCES

CN220687055U discloses a hinge for shower room door having a groove protecting screws, outside of which a waterproof cover is installed.
CN220687055U discloses a door having a waterproof hidden connection structure. A waterproof edge is implemented that prevents moisture from penetrating into a joint, thereby avoiding the problem that the door panel is corroded because of moisture.
CN220687055U discloses a glass connection structure for glass shower room (e.g., modern shower door) that includes a mounting frame. The waterproofing of the connection structure is focused on a friction fit between a vise-like structure and a glass door/wall.
US20240101224A1 discloses a water resistant storage assembly for a boat or other vehicle including a drawer assembly or a hinged-door assembly coupled to a cabinet, wall, or other compartment. The storage assembly may include a series of faces featuring or defining self-draining channels adapted to redirect inbound water or other fluids away from the interior storage area and towards an external wall or other external surface.
CN220735235U discloses a linkage structure for shower partition door discloses comprises a sliding mechanism arranged on partition door.
Other notable art references include CN209058986U, CN205433511U, CN201661165U, and CN209990297U.

### SUMMARY OF THE EMBODIMENTS

One aspect of the disclosure is directed to a method for installing a frameless shower (see FIG. 1C), which includes placing a gasket that forms a watertight seal between a shower clamp and a wall surface. The shower clamp can be secured to a supporting surface (wall, ground, or overhead) via screws passing through the shower clamp, the gasket, and the wall surface.

The shower clamp(s) used in the installation can include pivot hinges used to install a glass shower door, which may be placed perpendicular to a wall surface.

The frameless shower door, when installed, can open/close in a ninety-degree arc/angle, typically outwardly from the shower's interior. Each of the pivot hinge and corresponding gasket include aligned interior holes through which screws pass. In the method, plates of each of the pivot hinges are separated and the glass door is placed therebetween. Often a concavity exists for this placement, as shown by FIG. 1B. The plates on each of the pivot hinges are tightened to secure the glass door therebetween. Holes are drilled in the wall surface for screws, which are positioned for securing the pivot hinges. Screw anchors are placed in each of the drilled holes. The glass door and the coupled pivot hinges are placed proximate to the wall with the gaskets positioned therebetween, so that the interior holes align with the drilled holes. The pivot hinges are attached to the wall surface via the screws. A similar process occurs for securing glass panes or dividers to a wall surface, except the coupler in such an arrangement is not able to pivot.

Another aspect of the disclosure is directed to a shower clamp assembly for securing a plane (e.g., divider/door) to a wall surface. The plane can be a vertical plane of a shower divider, whether the plane represents a door or a shower wall. The shower clamp includes a wall mount plate (e.g., planer surface with holes attached to wall surface) and a plane retaining clamp (e.g., portion that clamps or holds the shower door/wall). The wall mount plate has at least two holes through which screws extend to secure the wall mount plate to the wall surface. The plane retaining clamp includes two parallel clamp plates connected via a clamp plate coupler (e.g., often a screw). The clamp plate coupler is configured to adjust a distance between the parallel clamp plates within a clamp range. In simple terms, at least one of the plates can be removed, positioned near the door/divider or concavity thereof, and reattached to the other plate via the screw. As presented, the clamp plates are configured to secure a plane of material between the parallel clamp plates by minimizing the distance after the plane (e.g., shower door/wall) is secured between. The assembly includes a gasket configured to be positioned between the wall mount plate and the wall surface when mounted via the screws.

The gasket is constructed of a compressible solid material, said gasket having a relatively flat, relatively planar surface with a gasket outer perimeter substantially equivalent to a plate outer perimeter of the wall mount plate. In layman's terms, the gasket is solid, flat, pre-drilled, and sized to fit. Generally, the gasket will be a rubber or similar compressible material. Other potential materials including polyvinyl chlorides, polyethylene, polyethylene vinyl acetate, polypropylene, high density polyethylene, or co-polymers thereof. In one embodiment, it can have a waffle or textured surface, which enhances the waterproofing aspect when tightened via the screws. The gasket includes at least two gasket holes within the interior of the gasket outer perimeter. Each gasket hole corresponds positionally to one of the wall mount plate holes, such that the screws pass through. When the wall mount plate is mounted to the wall surface via the screw with the gasket positioned therebetween, the gasket forms a watertight seal between the wall mount plate and the wall surface.

In one arrangement, the compressible solid material provides a screw tightening effect (much like a lock washer) allowing the wall mount plate to be better secured to the wall than it would be if the compressible solid material for the gasket were not used.

In one arrangement, a shower clamp is one of many shower clamps that support one end of the vertical plane and secure that end to the wall surface. When installed via the clamps, the vertical plane is suspended in the air above the ground surface. Thus, the shower clamps support at least a portion of the load of the weight of the vertical plane. The set of clamps can be distributed in a vertical line on the wall surface. A total distance between the clamps is less than the vertical length of the vertical plane. In other words, if two clamps are used, one is positioned close to a top of the vertical plane and another close the bottom. If three clamps are used, the additional one is positioned near the middle of an even distribution of clamps.

In one arrangement, the vertical plane can be a glass plane, which is a divider surface or wall portion of a frameless shower. In another arrangement, the vertical plane can be a shower door, which pivots when installed, and also may be constructed of glass, which may be tempered, frosted glass, low iron, textured glass, or tinted glass, or combinations thereof (most shower doors utilized herein are tempered).

In one embodiment, a plate surface of the wall mount plate closest to the wall surface can have a recessed region. The gasket outer perimeter fits within the recess. This provides an appearance of the plate being close to the wall surface, instead of being visibly separated via the gasket's width, giving the door an aesthetic appearance.

In one embodiment, a surface of the gasket facing the wall mount plate can include a raised outer lip that the plate outer perimeter fits within. In embodiments, an outer recess can exist in the outer perimeter of the plate so that it “fits” in a planer fashion despite the gasket having an outer lip. In one embodiment, the gasket can have a waffle surface, which deforms when compressed to strengthen liquid tight seal when the screws are tightened.

Another aspect of the disclosure is directed to a gasket waterproofing kit for securing a shower clamp for a frameless shower to a wall surface. The kit can include a gasket positioned between the shower clamp and the wall surface when mounted via the screws. The gasket is formed of a compressible solid material as disclosed herein. In an embodiment, the gasket has a relatively flat, relatively planar surface with a gasket outer perimeter substantially equivalent to an outer perimeter of the clamp surface closest to the gasket wall mount plate. Substantially equivalent can mean approximately the same as well as being shared with one or more lips or recesses so that one fits inside the other. Each gasket has at least two gasket holes that correspond positionally to screw holes in the shower clamp through which the screws extend when mounted to the wall surface. The gasket is configured to form a watertight seal between the wall surface and the shower clamp when mounted.

In one embodiment, a surface of the shower clamp closest to the wall surface is recessed, where the gasket outer perimeter fits within the recess of the wall mount plate. In an embodiment, a surface of the gasket facing the shower clamp includes a raised outer lip that a perimeter of a surface of the shower clamp closest to the wall surface fits within. The gasket can have a waffle surface, which deforms to strengthen the liquid tight seal when the screws are tightened.

In one embodiment, the kit includes a set of wall anchors and screws, each sized for the wall anchors, the gasket holes, and holes in the shower clamp. The kit can also include the shower clamp and/or a set of multiple shower clamps and related components. For example, a kit can be for a shower door and include two clamps that are each a pivot hinge clamp. In another embodiment, the kit can further include the shower door itself. In one embodiment, an entire glass shower kit can include all components for installing a shower door and/or shower glass components and instructions for the same. The instructions may be a part of the kit. The kit may also include instructions about how to access a web site that optionally contains one or more videos that shows how the shower door and associated components can be installed.

In one embodiment, a set of different gaskets can be included for a set of one or more shower clamps. The set includes differently angled gaskets. Specifically, one with an angle of zero, and at least two having angles under five but greater than zero degrees between the wall facing plane and the clamp facing plane. These multiple gaskets of different angles are able to correct for defects in the wall surface being not perfectly level/square. In other words, the different angled gaskets function like shims to “square” components to a less than perfect mounting.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1A (PRIOR ART) shows a pivot hinge kit.

FIG. 1B (PRIOR ART) shows an installation image of a pivot hinge to a shower door.

FIG. 1C shows a modern, frameless shower door with pivot hinges.

FIG. 2A is a diagram of a kit that incorporates a gasket for a shower clamp (or pivot hinge) in accordance with embodiments of the disclosure.

FIG. 2B is a diagram showing shower elements connected to a surface via a shower clamp having a gasket that forms a watertight seal in accordance with embodiments of the disclosure.

FIG. 3A is a diagram of a pivot hinge in accordance with embodiments of the disclosure.

FIG. 3B is a diagram of two illustrative gaskets in accordance with embodiments of the disclosure.

FIG. 3C is a diagram of pivot hinges with matching gaskets in accordance with embodiments of the disclosure.

FIG. 3D shows a closeup of a gasket with waffle effect material in accordance with embodiments of the disclosure.

FIG. 4 is a diagram of a perspective view of the shower clamp of FIGS. 2B and 3A with a first clamp plate and a second clamp plate in accordance with some embodiments.

FIG. 5A shows a 2 inch by 2 inch square clamp with square corners.

FIG. 5B shows a 2 inch by 2 inch square clamp with beveled corners.

FIG. 5C shows a no fabrication clamp clip.

FIG. 5D shows a no fabrication clamp clip with set screws.

### DESCRIPTION OF THE PREFERRED EMBODIMENTS

The preferred embodiments of the present invention will now be described with reference to the drawings. Identical elements in the various figures may be identified with the same reference numerals. Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As used herein, the singular forms “a,” “an,” and “the,” are intended to include the plural forms as well, unless the context clearly indicates otherwise.

The phrase “and/or,” as used herein in the specification and in the claims, should be understood to mean “either or both” of the elements so conjoined, i.e., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that other elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

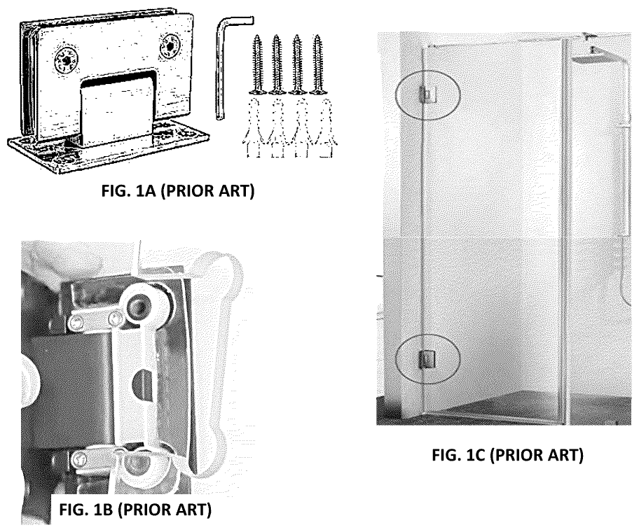

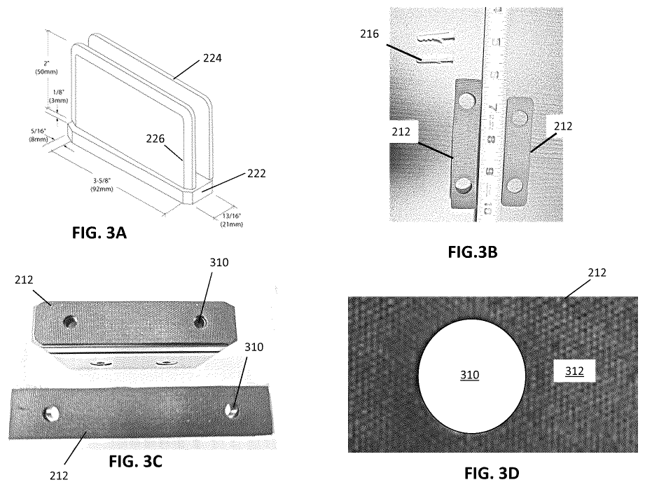

A significant concern in bathroom construction is water intrusion, which is especially prevalent in installations requiring drilling holes into bases or sills for pivot hinges, such as those shown in FIG. 1A and FIG. 1C (both PRIOR ART). Water intrusion is significantly lessened or eliminated all together through incorporation of a waterproof gasket 212, such as that shown in FIG. 3B. When the hinge or shower clamp 220 is tightened during installation, it activates a waffle effect within the gasket, which strengthens the watertight seal. A gasket 212 image of a waffle effect 312 is shown in FIG. 3D by the noted non-smooth surface. The waffle effect 312 design intricately creates tight air pockets, effectively locking out water and preventing penetration at the installation site.

Use of the gasket 212 is a robust solution to a common problem, which does not compromise on the design or structural integrity of the installation. As shown in FIG. 3C, the gasket 212 is a solid, flexible material with a set of holes 310 matching those in a wall mount plate 222 of a shower clamp 220 (or pivot hinge). Screws 214 are inserted through the respective holes and into a wall surface, possibly which includes anchors 216. The gasket 212 may provide better hold of the screws when mounted to the wall (much like a lock washer) as the compressibility of the gasket provides a tighter fit. The gasket may also reduce the incidence of damage to the wall (whether it be tile or dry wall) when the clamp wall mount plate is attached to the wall due to the compressibility of the gasket. The gasket may also have a suction effect so that when attached to the wall it provides better cohesion with the wall, further reducing the incidence of water intrusion/seepage.

In an embodiment, the screws generally are corrosion-resistant screws. The screws in a variation, are stainless steel or brass. To the extent that the screws may be an aesthetic feature of the shower door/shower pane, the use of a stainless steel or brass screw may provide this aesthetic feature. The wall mount plate may also allow for the screws to be recessed into the wall mount plate, which may have rubber and/or plastic caps affixed to the screw heads to further diminish water penetration along the length of the screws.

The gasket 212 can have many sizes and shapes. Generally, the perimeter (e.g., outer edge of a flat gasket) will be substantially the same as that of the wall mount plate 222. Thus, when installed, the gasket 212 is effectively invisible (see FIG. 3C showing view of gasket connected to a shower clamp 220). When the shower clamp is a pivot hinge, such as that shown on FIG. 1A, it is substantially rectangular and has four holes. When the wall mount plate 222 is rectangular and has two holes, so does the gasket 212, as shown in FIGS. 3B and 3C. In embodiments, the gasket 212 can have an outer lip, which the wall mount plate 222 fits within. In other embodiments, the wall mount plate 222 can have a recess (or concavity) that the gasket 212 fits within. Both situations (lipped and recessed) are considered to have substantially the same perimeter.

With reference to FIG. 3A and FIG. 3B, an industry specific example of a gasket 212 for a heavy-duty hinge/shower clamp 220 can be 4″×0.875″ with 2.5″ holes that are 2.625″ on center. A gasket for a deluxe hinge/shower clamp 220 can be 3.5″×0.875″ with 2.5″ holes that are 2.625″ on center. In one embodiment, a special anchor that has a 1/32″ lip that is compressible along with the gasket can be used. The waffle effect 312 material can be a black, flexible rubber material forming the gasket 212 with waffle design, which may have a durometer of 60-shore. The shore hardness may be adjusted depending on the material to which the wall plate is to be mounted. Any kit that contains the components for shower door and shower pane assembly may contain a plurality of gaskets with different shore values. For example, if the wall mount plate is to be mounted to tile, a harder gasket may be preferred with softer gaskets preferred when mounted to dry wall. In one embodiment, either gasket can be sold by itself, as part of a kit that includes anchors, can be adhered (or sold with) the hinges or shower clamp 220 with which it is to be used. In embodiments, a full installation kit including the gaskets can be a “complete” kit that includes a shower door and shower panels, and any of the other components described herein.

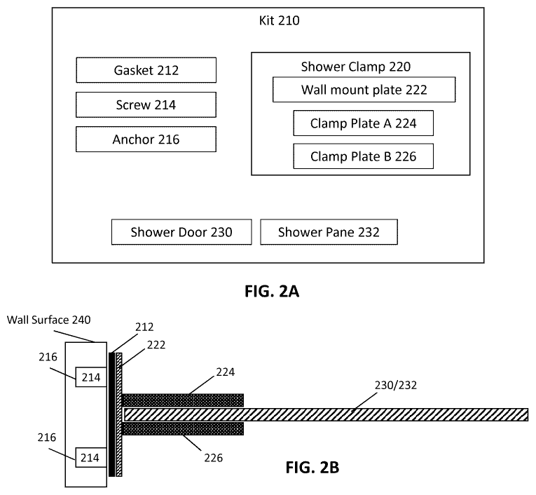

More generally, and as noted by FIG. 2A, a frameless shower installation kit 210 (or shower clamp kit) must include one or more gaskets 212. It may also include screw(s) 214 and wall anchors 216. In a further embodiment, kit 210 includes the shower clamp 220 itself. When the clamp 220 is included, the gasket 212 may be secured to a surface of plate 222 via an adhesive at the time of purpose; or the gasket 212 can be loose from the clamp 220. In a complete kit, 210 a shower door 230 (such as that shown in FIGS. 1A, 1C) and/or shower pane 232 or set thereof is included.

Alternatively and/or additionally, an adhesive may be included to provide additional adhesion. For example, a 100% silicon sealant may be included in a kit. The sealant may be included for gaps, or for other purposes to provide a watertight and secure installation.

With reference to FIG. 2B, generally clamp 220 is installed against a pane, sill, or surface 240, which is often a wall. Holes can be drilled, and anchor(s) 216 preinserted. As noted, the anchors may compress when screws 214 are tightened. Next to the surface 240 of the wall, is the gasket 212, which is adjacent to a wall mount plate 222 of the clamp 220. Clamp 220 has two parallel and opposing plates, which are referred to as clamp plate A 224 and clamp plate B 226. The door 230 or plane 232 is sandwiched between the plates 224, 226. Installation can be similar to that shown in FIG. 1B, or may involve a friction, fricative and/or compression fit, where the plane of the door 230, pane 232, or other similar divider is held/secured by an inward tightening of the plates 224, 226. That is, a coupler, such as a set of one or more screws, can be used to affix the plates 224, 226 to each other, where the coupler tightens within a range (that of the threads/screw).

It should be appreciated (see FIG. 1C) that clamp 220 may support a significant amount of weight, such as an entire shower door that pivots outwardly being supported by two pivot hinges, which are attached to a wall. When the clamp 220 is a pivot hinge (with reference to FIG. 2B), the hinge allows plates 224, 226 to rotate relative to plate 222. A “default position” can be plate 222 being at an approximately 90-degree angle to the plates 224, 226. This angle is adjustable in implementations, such as when a shower door (230) is angled when closed, such as at a 60 degree angle relative to a supporting wall 240 instead of a default 90 degree angle.

In a preferred embodiment, the shower clamp 220 is a pivot hinge that secures a glass shower door 230 from top to bottom. This hinge may allow a door to spin 180 degrees, or even a full 360 degrees. Pivot hinges are typically attached at the top and bottom of the door, creating a modern frameless view. In one embodiment, a side-mount wall hinge (which is another variant of the shower clamp 220) can be utilized instead of a pivot hinge, yet with a smaller profile. Different pivot hinges can be mounted to a wall 240, a ground surface, and/or a top surface. Regardless of the type of surface, gasket 212 creates a watertight seal. A shower glass clamp (e.g., RANBO shower panel mounting bracket with UPC 680904998544 available via AMAZON and other sites) is effectively the same as a pivot hinge, but it does not pivot. It still secures a pane to a surface, which is facilitated by gasket 212. More generally, shower clamps 220 are designed or configured to hold glass panels in place and to provide secure attachment to the wall or floor.

Gasket 212 is a connection between two components or flanges that have relatively flat surfaces and are used at union to prevent leaking. Gasket 212 withstands exposure to water from the shower without damage or loss of function. Gasket 212 prevents seeping of water into the surface 240, which would result in rotting, which results in screw 214 becoming less secure over time. In the case of a supported glass door 230 (e.g., FIG. 1C), this causes the door to pivot improperly, such as by scraping against the ground or into a pane of glass.

A screw 214 is a common coupler more formally defined as a simple machine of the inclined plane type consisting of a spirally grooved solid cylinder and a correspondingly grooved hollow cylinder into which it fits. That is, a screw 214 can be described as a short, slender, sharp-pointed metal pin with a raised helical thread running around it and a slotted head, used to join things together by being rotated so that it pierces wood or other material and is held tightly in place.

An anchor 216 or screw anchor is a specialized fastener that can secure objects to materials that may not be otherwise suitable for screws 214. Anchors 216 can be made from a variety of materials, including plastic, metal, or fiber, and come in different sizes and configurations. Screw anchors 216 work by expanding or gripping the material into which they are inserted (e.g., wall surface 240) to create a secure hold.

Shower door 230 and shower pane 232 can be made of glass or similar material. Preferably tempered glass is used to ensure that if a door 230/pane 232 breaks it fractures into dull regular cubes instead of jagged shards. Tempered glass is preferred as it is durable, elegant, and allows light to pass through, making the shower feel bright and inviting. Other types of glass that can be used for shower doors 230 and panes 232 include laminated glass, which is made by adhering two sheets of glass to a vinyl sheet, and SHOWERGUARD glass, which is permanently sealed during manufacturing to make it easier to clean and more resistant to staining and corrosion.

Acrylic, which is a clear plastic similar to glass, may be used for some embodiments for door 230 and/or pane 232.

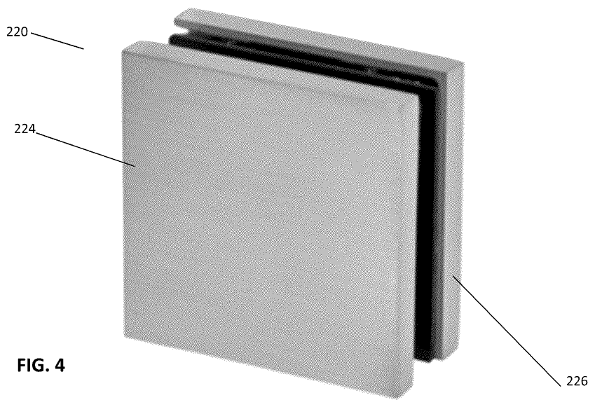

FIG. 4 is a diagram of a perspective view of the shower clamp 220 of FIGS. 2B and 3A with a first clamp plate 224 and a second clamp plate 226 in accordance with some embodiments. In an embodiment, the clamps shown are stationary brackets that securely mount to both the wall and floor, typically used in frameless shower installations or glass partition systems. The clamp assembly consists of a first clamp plate 224 and a second clamp plate 226, which sandwich the glass pane between them, providing stability and support. Both the first and second clamp plates are configured to grip on the glass without causing damage. The plates are typically composed of corrosion-resistant materials, such as stainless steel or brass, to ensure durability in humid environments including, but not limited to, bathrooms. Between the clamp plates, rubber or silicone gaskets are inserted to protect the glass from direct metal contact, reduce the risk of breakage, and provide additional friction for secure holding.

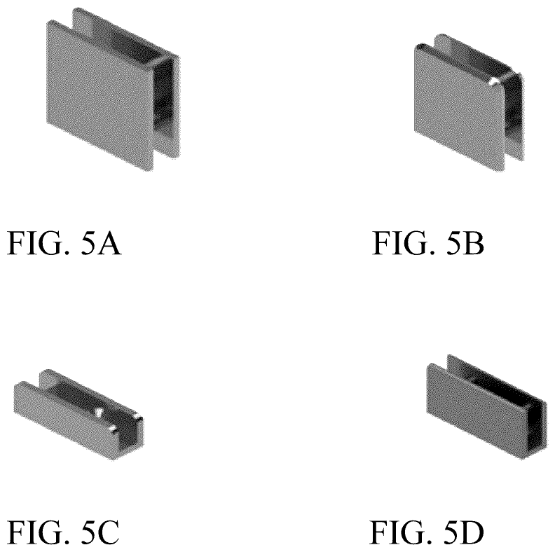

FIGS. 5A to 5D show other clamps of the invention that can be used with gaskets. FIG. 5A shows a 2 inch by 2 inch square clamp with square corners. FIG. 5B shows a 2 inch by 2 inch square clamp with beveled corners. FIG. 5C shows a no fabrication clamp clip. FIG. 5D shows a no fabrication clamp clip with set screws.

The clamp plates are fastened together via concealed fasteners including, but not limited to, screws or bolts, which allow for easy installation and adjustment. In some embodiments, the clamp assembly may have a sleek exterior finish such as in a brushed or matte metal finish to facilitate an aesthetically pleasing design that complements modern interiors. In addition, the plates may include a slight lip or groove to guide the correct positioning of the glass panel during installation, ensuring alignment. In some embodiments, the clamp plates can be configured for use with varying glass thicknesses, accommodating standard thicknesses ranging from about 8 mm to about 12-13 mm, or even thicker panels for specialized applications. The stationary nature of these brackets ensures that once installed, the glass panels remain securely in place, providing structural integrity to frameless glass systems.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A shower clamp assembly for securing a vertical plane to a surface of a wall, comprising:
a mount plate having at least two openings through which a fastener to be received by the at least two openings, the fastener to extend to secure the mount plate to the surface of the wall;
a plane retaining clamp comprising two parallel clamp plates connected via a clamp plate coupler configured to adjust a distance between the two parallel clamp plates within a clamp range, wherein the two parallel clamp plates are configured to secure a plane of material between the two parallel clamp plates by minimizing the distance after the plane is secured between; and
a gasket configured to be positioned between the mount plate and the surface of the wall when mounted via the fastener, wherein said gasket is a compressible solid material, said gasket having a relatively planar surface with an outer perimeter of the gasket substantially equivalent in size to an outer perimeter of the mount plate, wherein the gasket comprises at least two gasket openings within an interior of the outer perimeter of the gasket, wherein each of the at least two gasket openings corresponds positionally to the at least two openings of the mount plate, such that each fastener passes through the at least two openings of the mount plate and the at least two gasket openings, wherein the mount plate is mounted to the surface of the wall via the fastener with the gasket positioned therebetween, wherein the gasket forms a water tight seal between the mount plate and the surface of the wall.

2. The shower clamp assembly of claim 1, further comprising:
a plurality of shower clamps that support one end of the vertical plane and secure that end to the surface of the wall, wherein when installed via the plurality of shower clamps, the vertical plane is suspended in air above a ground surface, wherein the plurality of shower clamps support at least a portion of a load of weight of the vertical plane, wherein when the vertical plane is supported by the plurality of shower clamps, the plurality of shower clamps are distributed in a vertical line on the surface with a total distance between of less than a vertical length of the vertical plane.

3. The shower clamp assembly of claim 1, wherein the vertical plane is a glass plane, which is a divider surface of a frameless shower.

4. The shower clamp assembly of claim 1, wherein the vertical plane is a stationary wall of a frameless shower, affixed in a stationary position relative to a wall surface by the shower clamp assembly.

5. The shower clamp assembly of claim 1, wherein the vertical plane is a shower door, wherein the shower clamp assembly is configured to pivot at least ninety degrees about an axis, which enables the shower door to open and close when mounted.

6. The shower clamp assembly of claim 1, wherein a plate surface of the mount plate closest to the surface of the wall has a recess, wherein the outer perimeter of the gasket fits within the recess of the mount plate, wherein the outer perimeter of the mount plate is greater than the outer perimeter of the gasket by a length attributable to a non-recessed portion of the plate surface.

7. The shower clamp assembly of claim 1, where a surface of the gasket facing the mount plate comprises a raised outer lip that the outer perimeter of the gasket fits within, wherein a size of the outer perimeter of the mount plate is less than a size of the outer perimeter of the gasket by a length attributable to the raised outer lip.

8. The shower clamp assembly of claim 1, wherein the gasket has a waffle surface, which deforms to strengthen liquid tight seal, when the fastener is tightened.

9. A gasket waterproofing kit for securing a shower clamp for a frameless shower to a surface of a wall, said gasket waterproofing kit comprising:
a gasket configured to be positioned between the shower clamp and the surface of the wall when mounted with one or more fasteners, wherein said gasket is a compressible solid material, said gasket having a relatively planar surface with an outer perimeter of the gasket substantially equivalent in size to an outer perimeter of a surface of the shower clamp closest to a wall mount plate of the gasket, wherein the gasket comprises at least two gasket holes within an interior of the outer perimeter of the gasket, wherein each of the at least two gasket holes corresponds positionally to one or more openings in the shower clamp through which the one or more fasteners extend when mounted to the surface of the wall, wherein the gasket is configured to form a liquid tight seal between the surface of the wall and the shower clamp when mounted.

10. The gasket waterproofing kit of claim 9, wherein a surface of the shower clamp closest to the surface of the wall has a recess, wherein the outer perimeter of the gasket fits within the recess of the wall mount plate.

11. The gasket waterproofing kit of claim 9, where a surface of the gasket facing the shower clamp comprises a raised outer lip that a perimeter of a surface of the shower clamp closest to the surface of the wall fits within.

12. The gasket waterproofing kit of claim 9, wherein the gasket has a waffle surface, which deforms to strengthen the liquid tight seal when the one or more fasteners are tightened.

13. The gasket waterproofing kit of claim 9, further comprising:
a plurality of wall anchors.

14. The gasket waterproofing kit of claim 13, further comprising:
a plurality of screws, each sized for the plurality of wall anchors, the at least two gasket holes, and holes in the shower clamp.

15. The gasket waterproofing kit of claim 9, wherein the shower clamp is one of a pivot hinge for hanging a door of a frameless shower and a wall mount for securing a wall divider of a frameless shower, wherein the gasket is configured to work with both the pivot hinge and the wall mount.

16. The gasket waterproofing kit of claim 14, wherein the kit is part of a frameless shower installation kit comprising sufficient quantities of the gasket, the plurality of wall anchors, and the plurality of screws to install a frameless shower.

17. The gasket waterproofing kit of claim 12, wherein the gasket is one of a plurality of gaskets including a set of differently angled gaskets, wherein each of the plurality of gaskets have a clamp facing plane and a wall facing plane, wherein the set of differently angled gaskets comprise:
at least one gasket where the clamp facing plane and the wall facing plane are substantially parallel; and
at least two gasket having angles under five but greater than zero degrees between the wall facing plane and the clamp facing plane,
wherein one of the different gaskets in the kit are selected to correct for defects in the wall surface being not perfectly square, which would otherwise negatively affect a hanging of the frameless shower.

18. A method for installing a frameless shower comprising:
placing a gasket that forms a watertight seal between a shower clamp and a wall surface; and
securing the shower clamp to the wall surface via screws passing through the shower clamp and the wall surface.

19. The method of claim 18, wherein frameless shower comprises a glass door, wherein the shower clamp is a set of pivot hinges that secures the glass door to the wall surface, wherein each of the set of pivot hinges and the gasket comprise interior holes through which the screws are configured to pass, said method further comprising:
separating plates of each of the set of pivot hinges and placing the glass door therebetween;
tightening the plates on each of the set of pivot hinges to fictively secure the glass door therebetween;
drilling holes in the wall surface for screws, which are positioned for securing the set of pivot hinges;
placing screw anchors in each of the drilled holes;
positioning the glass door and the set of pivot hinges proximate to the wall with the gaskets positioned therebetween, so that the interior holes align with the drilled holes; and
attaching the set of pivot hinges to the wall surface via the screws.

20. The method of claim 18, wherein frameless shower comprises a glass pane that is a wall of the shower, wherein the shower clamp is one of two wall securing fixed positioned clamps, wherein each of the shower clamps and corresponding gaskets comprise interior holes through which the screws are configured to pass, said method further comprising:
separating plates of each of the of pivot hinges and placing the glass pane therebetween;
tightening the plates on each of the pivot hinges to fictively secure the glass pane therebetween;
drilling holes in the wall surface for screws, which are positioned for securing the shower clamps;
placing screw anchors in each of the drilled holes;
positioning the glass pane and the shower clamps, so that the interior holes align with the drilled holes; and
attaching the shower clamps to the wall surface via the screws.
